(19) United States
(12) Patent Application Publication
(10) Pub. No.: US 2018/0253088 A1
(43) Pub. Date: Sep. 6, 2018

(54) NON-FUNCTIONAL REQUIREMENT STIMULUS TESTING FOR ROBOTS

(71) Applicant: International Business Machines Corporation, Armonk, NY (US)

(72) Inventors: Kristina Y. Choo, Chicago, IL (US); Krishnan K. Ramachandran, Campbell, CA (US); Gandhi Sivakumar, Bentleigh (AU)

(21) Appl. No.: 15/446,526

(22) Filed: Mar. 1, 2017

(51) Int. Cl. G05B 23/02; G04F 10/00

(52) U.S. Cl. CPC G05B 23/0208; G04F 10/00; G05B 2219/40602; G05B 2219/40323; G05B 2219/45089

(57) ABSTRACT

In an approach to non-functional requirement stimulus testing of a robot, one or more computer processors receive one or more stimulus parameters to test. The one or more computer processors trigger the one or more stimulus parameters in the robot. The one or more computer processors determine at least one response time to the one or more stimulus parameters.

### BACKGROUND OF THE INVENTION

The present invention relates generally to the field of robotics, and more particularly to non-functional requirement stimulus testing for robots.

Non-functional testing is the testing of a software application or system for its non-functional requirements. A non-functional requirement is a requirement that specifies criteria that can be used to judge the operation of a system, rather than specific behaviors. They are contrasted with functional requirements that define specific behavior or functions. Broadly, functional requirements define what a system is supposed to do and non-functional requirements define how well it should be done, i.e., non-functional requirements are quantified and testable.

General-purpose autonomous robots can perform a variety of functions independently. General-purpose autonomous robots typically can navigate independently in known spaces, handle their own re-charging needs, interface with electronic doors and elevators and perform other basic tasks Like computers, general-purpose robots can link with networks, software and accessories that increase their usefulness. They may recognize people or objects, talk, provide companionship, monitor environmental quality, respond to alarms, pick up supplies and perform other useful tasks. General-purpose robots may perform a variety of functions simultaneously or they may take on different roles at different times of day.

Currently, many industries are trending toward cognitive models enabled by big data platforms and machine learning models. Cognitive models, also referred to as cognitive entities, are designed to remember the past, interact with humans, continuously learn, and continuously refine responses for the future with increasing levels of prediction. An example of a cognitive model interface is a cognitive robot. Cognitive robotics is concerned with endowing a robot with intelligent behavior by providing it with a processing architecture that enables it to learn and reason about how to behave in response to complex goals in a complex world.

### SUMMARY

Embodiments of the present invention disclose a method, a computer program product, and a system for non-functional requirement stimulus testing of a robot. The method may include one or more computer processors receiving one or more stimulus parameters to test. The one or more computer processors trigger the one or more stimulus parameters in the robot. The one or more computer processors determine at least one response time to the one or more stimulus parameters.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a controller program, on a non-functional requirements stimulus tester within the distributed data processing environment of FIG. 1, for testing responses to stimuli by a robot, in accordance with an embodiment of the present invention; and

FIG. 3 depicts a block diagram of components of the non-functional requirements stimulus tester executing the controller program within the distributed data processing environment of FIG. 1, in accordance with an embodiment of the present invention.

### DETAILED DESCRIPTION

A cognitive robot (CR) is expected to naturally interact with humans, learn concepts and behaviors, and become a part of a human community. A CR is built with software components integrated with kinematic gesture components, resulting in a robot that responds and moves by perceiving signals through sensors, audio interfaces, visual interfaces, etc. For a CR to be considered a cognitive companion, serving as a supplement for performing many human functions, the CR is expected to deliver at least the same level of accuracy, quality, and throughput as may be delivered by a human. Current non-functional requirements testing mechanisms for various types of robots, including CRs, lack a standards-based, configurable framework. Additionally, a cognitive interface can possess the intelligence to sense unknown elements through various sensors and respond differently. For example, when a CR senses smoke for the first time, the CR may need to respond and act faster as compared to, in the future, when smoke becomes a known element. Embodiments of the present invention recognize that non-functional requirements stimulus testing of robots can be accelerated and improved by providing a test framework that enables defining an extensible, standards-based interface for testing reaction time of physical components of a robot to various sensory stimuli as the cognitive interface matures. Implementation of embodiments of the invention may take a variety of forms, and exemplary implementation details are discussed subsequently with reference to the Figures.

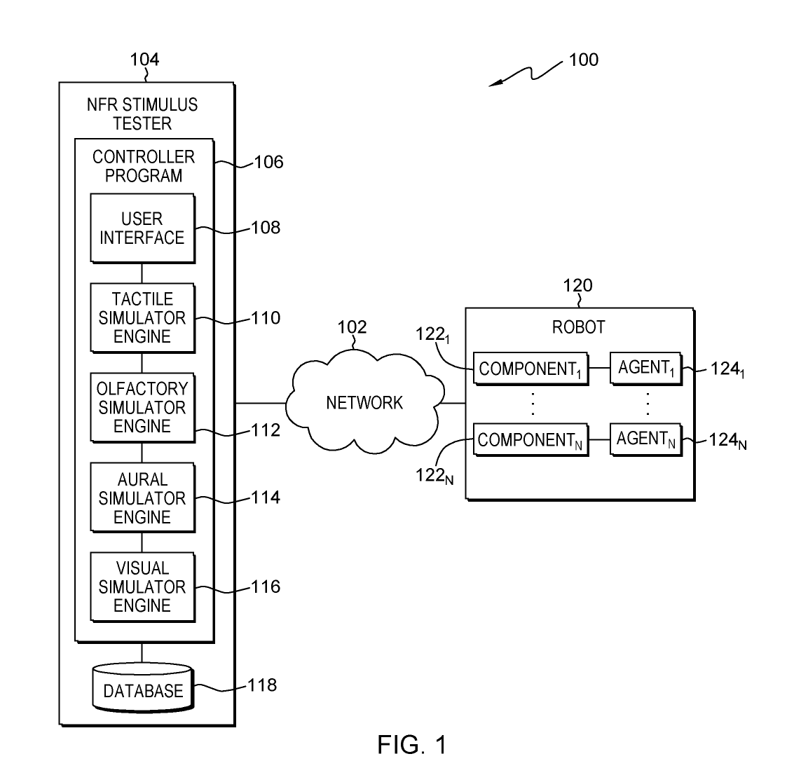

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes non-functional requirements (NFR) stimulus tester 104 and robot 120 interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between NFR stimulus tester 104, robot 120, and other computing devices (not shown) within distributed data processing environment 100.

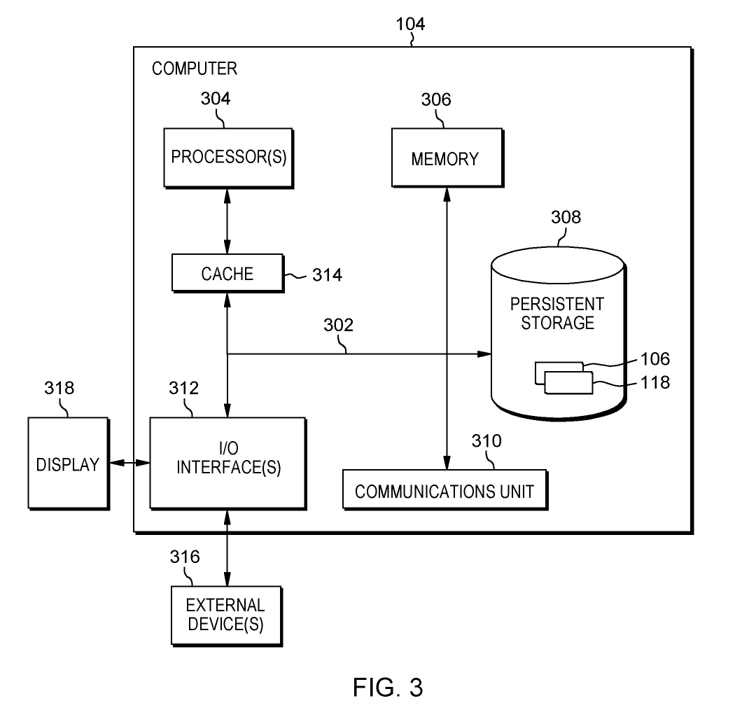

NFR stimulus tester 104 can be a standalone computing device, a management server, a web server, a mobile computing device, or any other electronic device or computing system capable of receiving, sending, and processing data. In other embodiments, NFR stimulus tester 104 can represent a server computing system utilizing multiple computers as a server system, such as in a cloud computing environment. In another embodiment, NFR stimulus tester 104 can be a laptop computer, a tablet computer, a netbook computer, a personal computer (PC), a desktop computer, a personal digital assistant (PDA), a smart phone, or any other programmable electronic device capable of communicating with robot 120 and other computing devices (not shown) within distributed data processing environment 100 via network 102. In another embodiment, NFR stimulus tester 104 represents a computing system utilizing clustered computers and components (e.g., database server computers, application server computers, etc.) that act as a single pool of seamless resources when accessed within distributed data processing environment 100. NFR stimulus tester 104 includes controller program 106 and database 118. NFR stimulus tester 104 may include internal and external hardware components, as depicted and described in further detail with respect to FIG. 3.

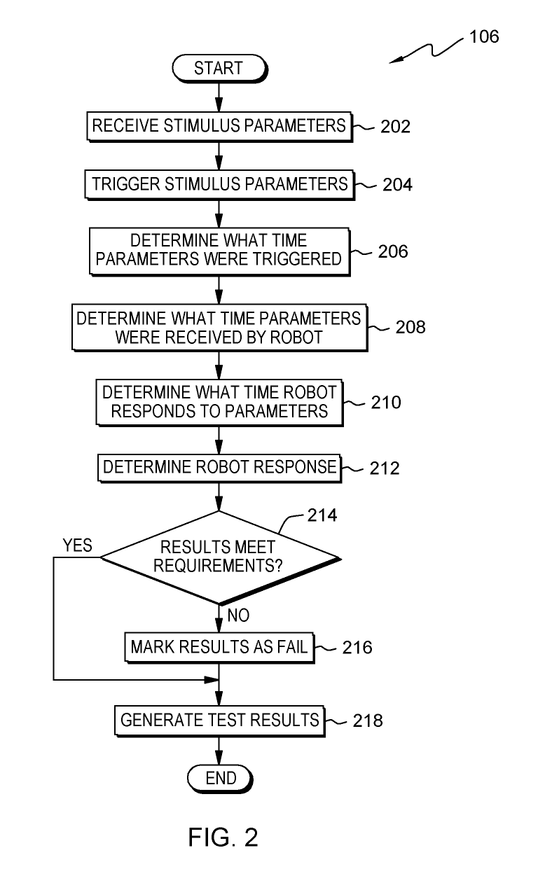

Controller program 106 provides a configurable non-functional requirements testing framework for testing robot reaction times to external stimuli. At runtime, controller program 106 identifies a list of agents associated with one or more physical robotic components, tests stimulus response parameters to external stimuli by executing commands, via the agents, using the physical robotic components, compares results to required criteria, tolerances, and acceptable threshold values for each of the defined stimuli, and provides a report to the user. In the depicted embodiment, controller program 106 resides on NFR stimulus tester 104. In another embodiment, controller program 106 may reside on robot 120. Controller program 106 includes user interface 108, tactile simulator engine 110, olfactory simulator engine 112, aural simulator engine 114, and visual simulator engine 116. In one embodiment, the functionality of tactile simulator engine 110, olfactory simulator engine 112, aural simulator engine 114, and visual simulator engine 116 are integrated into one component included within controller program 106. In one embodiment, controller program 106 includes one or more additional simulator engines (not shown) which provide stimuli for other types of sensing capabilities. For example, controller program 106 may include a taste simulator engine. Controller program 106 is depicted and described in further detail with respect to FIG. 2.

User interface 108 provides an interface to controller program 106 on NFR stimulus tester 104 for a user to define and perform non-functional requirement stimulus testing on robot 120. In one embodiment, user interface 108 may be a graphical user interface (GUI) and can display text, documents, web browser windows, user options, application interfaces, and instructions for operation, and include the information (such as graphic, text, and sound) that a program presents to a user and the control sequences the user employs to control the program. In another embodiment, user interface 108 may also be mobile application software that provides an interface to controller program 106 on NFR stimulus tester 104. Mobile application software, or an “app,” is a computer program designed to run on smart phones, tablet computers and other mobile devices. User interface 108 may include the ability to accept a user's commands for robot 120 via audio input (received and configured using natural language processing), visual input, and other non-text methods of receiving a command known in the art. User interface 108 enables the user to define standards-based stimulus response parameters for physical components of robot 120. For example, stimulus response parameters can include, but are not limited to, action types such as sequential, parallel, singular, complex, and varying speeds, i.e., low, medium, and high. In another example, stimulus response parameters can include, but are not limited to, audio responses, which may vary in loudness or frequency. Additionally, each response parameter is associated with an acceptable response time or acceptable range of response times. User interface 108 may also enable the user to define criteria, tolerances, and acceptable threshold values for each of the defined stimulus response parameters to be tested during non-functional requirements testing. For example, a user can define a tolerance for response time for a particular physical component as moving within 0-20 milliseconds after a stimulus is triggered. In another example, a user can define a tolerance for response time of an audio response as “speaking” within 0-20 milliseconds after a stimulus is triggered.

Tactile simulator engine 110 provides inputs to a sensory skin component of robot 120. Inputs may include a range of touch pressure types of tactile stimuli. For example, touch pressure may be low, medium or high. In the depicted embodiment, tactile simulator engine 110 resides in controller program 106. In another embodiment, tactile simulator engine 110 may reside in robot 120, or elsewhere within distributed data processing environment 100, provided tactile simulator engine 110 can establish communications with controller program 106 and robot 120 via network 102.

Olfactory simulator engine 112 provides inputs to one or more sensing capabilities of robot 120. Inputs may include one or more environmental factors that include olfactory characteristics. For example, olfactory simulator engine 112 may trigger smoke or humidity such that the stimulus response parameters of robot 120 can be measured. In the depicted embodiment, olfactory simulator engine 112 resides in controller program 106. In another embodiment, olfactory simulator engine 112 may reside in robot 120, or elsewhere within distributed data processing environment 100, provided olfactory simulator engine 112 can establish communications with controller program 106 and robot 120 via network 102.

Aural simulator engine 114 provides inputs to one or more sound sensing capabilities of robot 120. Inputs may include a range of various sound types of aural stimuli. For example, an audio level may be low, medium or high. Inputs may also include a range of angles from which the audio input emanates. In the depicted embodiment, aural simulator engine 114 resides in controller program 106. In another embodiment, aural simulator engine 114 may reside in robot 120, or elsewhere within distributed data processing environment 100, provided aural simulator engine 114 can establish communications with controller program 106 and robot 120 via network 102.

Visual simulator engine 116 provides inputs to one or more vision sensing capabilities of robot 120. Vision sensing capabilities include a plurality of camera types, including, but not limited to, normal and red eye types. Inputs may include various types of visual stimuli. For example, visual inputs may include an object, person, or event. In another example, visual inputs may include one or more images which may be a single, static image, a single image in motion, a compound static image, or a compound image in motion. In a further example, visual inputs may include measured luminescence in degrees such as dark, bright, very bright, and exposed. Inputs may also include a range of angles from which the visual input emanates. In the depicted embodiment, visual simulator engine 116 resides in controller program 106. In another embodiment, visual simulator engine 116 may reside in robot 120, or elsewhere within distributed data processing environment 100, provided visual simulator engine 116 can establish communications with controller program 106 and robot 120 via network 102.

Database 118 is a repository for data used by controller program 106. In the depicted embodiment, database 118 resides on NFR stimulus tester 104. In another embodiment, database 118 may reside elsewhere within distributed data processing environment 100 provided controller program 106 has access to database 118. A database is an organized collection of data. Database 118 can be implemented with any type of storage device capable of storing data and configuration files that can be accessed and utilized by controller program 106, such as a database server, a hard disk drive, or a flash memory. Database 118 stores stimulus response parameters and associated response time standards for components associated with non-functional stimulus testing requirements of responses performed by robot 120. In one embodiment, database 118 stores stimulus response parameters in a reference table. Database 118 may also store criteria, tolerances, and acceptable thresholds for each of the defined stimulus response parameters to be tested during non-functional requirement stimulus testing.

Robot 120 is a machine capable of automatically carrying out a complex series of actions. In one embodiment, robot 120 carries out action in response to computing instructions, also known as commands. In one embodiment, robot 120 is a general purpose autonomous robot. In various embodiments, robot 120 is a cognitive robot, i.e., robot 120 includes a machine learning component (not shown) which enables robot 120 to “remember” task outcomes and use that data to influence future task performance. In one embodiment, robot 120 is guided by an external control device. In another embodiment, robot 120 may be guided by an internal control device. In one embodiment, robot 120 may be constructed to take on human form. Robot 120 includes component(s) 122 and agent(s) 124. Robot 120 may also include a plurality of sensors, cameras, microphones, speakers, etc. that can receive and react to commands and sensory stimuli.

Component(s) 122 are one or more of a plurality of physical components which perform tasks, or a portion of a task, in response to a triggered stimulus. Component(s) 122 may be, for example, kinematic components such as motors which control the motion of “joints,” or nodes, such as shoulders, elbows, wrists, or fingers. Component(s) 122 may also include a plurality of sensors. A sensor is a device that detects or measures a physical property and then records or otherwise responds to that property, such as vibration, chemicals, radio frequencies, environment, weather, humidity, light, etc. Component(s) 122 may also include sensory skin that can react to a tactile stimulus. Component(s) 122 may also include a plurality of cameras that act as the vision system for robot 120.

Agent(s) 124 are one or more of a plurality of network-management software modules that reside on managed devices, such as robot 120. A software agent is a computer program that acts on behalf of a user or other program. Agent(s) 124 collect data from component(s) 122 and report the data back to controller program 106. Agent(s) 124 are specifically associated with one or more component(s) 122. For example, agent 124₁ is associated with component 122₁, and agent 124_{N} is associated with component 122_{N}, where N represents a positive integer, and accordingly the number of scenarios implemented in a given embodiment of the present invention is not limited to those depicted in FIG. 1. In another example, agent 124₁ may be associated with component 1221, component 122₂, and component 1223. In one embodiment, a group of agents may be referred to as a collection.

FIG. 2 is a flowchart depicting operational steps of controller program 106, on non-functional requirements (NFR) stimulus tester 104 within distributed data processing environment 100 of FIG. 1, for testing responses to stimuli by a robot, in accordance with an embodiment of the present invention.

Controller program 106 receives stimulus parameters (step 202). The user of NFR stimulus tester 104 provides a command to controller program 106 via user interface 108 to indicate which stimulus parameters to test as part of non-functional requirement stimulus testing. In one embodiment, the user speaks a verbose command and controller program 106 receives the command via natural language processing techniques known in the art. For example, the user may speak a command such as “Test aural stimulus using loud bang noise” or “Test visual stimulus using video.” In another embodiment, controller program 106 may receive the command via a text entry into user interface 108. In a further embodiment, controller program 106 may receive a command when the user displays a sign to robot 120, and vision systems in robot 120 (not shown) convert the words or symbols on the sign via techniques known in the art and transmit the command to controller program 106 via network 102.

Controller program 106 triggers the stimulus parameters (step 204). Based on the received stimulus parameters, controller program 106 triggers the appropriate stimuli via one or more simulator engines, i.e., tactile simulator engine 110, olfactory simulator engine 112, aural simulator engine 114, and visual simulator engine 116. For example, if the stimulus parameter tests the response of robot 120 to a tactile stimulus, then controller program 106 triggers tactile simulator engine 110 to induce a touch pressure on the sensory skin of robot 120 via either an internal component of NFR stimulus tester 104 (not shown), or via a remote component of distributed data processing environment 100 (not shown), within a detectable proximity of robot 120. In another example, if the stimulus parameter tests the response of robot 120 to an olfactory stimulus, then controller program 106 triggers olfactory simulator engine 112 to induce a change in humidity or the presence of smoke, via either an internal component of NFR stimulus tester 104 (not shown), or via a remote component of distributed data processing environment 100 (not shown), within a detectable proximity of robot 120. In a further example, if the stimulus parameter tests the response of robot 120 to an aural (i.e., audio) stimulus, then controller program 106 triggers aural simulator engine 114 to create a sound via either an internal component of NFR stimulus tester 104 (not shown), or via a remote component of distributed data processing environment 100 (not shown), within a detectable proximity of robot 120. In yet another example, if the stimulus parameter tests the response of robot 120 to a visual stimulus, then controller program 106 triggers visual simulator engine 116 to provide a visual input, such as a photographic image or a video clip via either an internal component of NFR stimulus tester 104 (not shown), or via a remote component of distributed data processing environment 100 (not shown), within a detectable proximity of robot 120.

Controller program 106 determines at what time the stimulus parameters were triggered (step 206). Controller program 106 captures the time at which the various simulator engines create and transmit the stimulus parameters to robot 120. In one embodiment, controller program 106 stores the time in database 118.

Controller program 106 determines at what time the stimulus parameters were received by the robot (step 208). Agent(s) 124 monitor and track component(s) 122 and communicate the timing of the parameter receipt to controller program 106 via network 102. Controller program 106 captures the time at which robot 120 receives the stimulus parameters, transmitted by the various simulator engines, from agent(s) 124. In one embodiment, agent(s) 124 monitor the time at which the stimulus parameters arrive at the operating system queue of robot 120. In one embodiment, controller program 106 stores the time in database 118.

Controller program 106 determines at what time the robot responds (step 210). Agent(s) 124 monitor and track the responses of component(s) 122 to the various stimuli and communicate the timing of the responses to controller program 106 via network 102. Controller program 106 captures the time at which robot 120 responds to the stimulus from agent(s) 124. If robot 120 responds with more than one action, such as an audio action plus a kinematic action, then controller program 106 captures the time of each response. In one embodiment, controller program 106 stores the time in database 118. In an embodiment, controller program 106 calculates a response time by comparing the time at which robot 120 receives a stimulus to the time at which robot 120 responds to the stimulus and noting the corresponding duration.

Controller program 106 determines the robot response (step 212). When robot 120 responds to the transmitted stimulus parameters, controller program 106 determines the type of response as well as any metadata included with the response. Required responses to various stimuli are pre-defined by the user, via user interface 108, and stored in database 118. In one embodiment, the user pre-defines a range of acceptable responses. In another embodiment, the user may pre-define a threshold which the response must meet. In a further embodiment, the user may pre-define more than one acceptable response for a particular stimulus trigger. Agent(s) 124 monitor and track the responses of component(s) 122 to the various stimuli and communicate the responses to controller program 106 via network 102. For example, in response to a tactile stimulus, robot 120 may respond with an audio output, such as saying “You're pinching me,” or with a kinematic output, such as moving the component that receives the tactile stimulus. In the example, controller program 106 may determine metadata such as the clarity of the audio response or the angular velocity, final angle and final position of the moving component. In one embodiment, robot 120 may pre-empt an action currently in progress such that robot 120 can respond to a newly received stimulus parameter. For example, if controller program 106 triggers tactile simulator engine 110 to induce a touch pressure on the sensory skin of robot 120 while robot 120 is responding to an aural stimulus, then robot 120 may pause the response to the aural stimulus and prioritize a response to the tactile stimulus. Stimulus response priorities may be stored in database 118.

Controller program 106 determines whether the results meet a requirement (decision block 214). Controller program 106 compares the results tracked by agent(s) 124 to the criteria, tolerances, and acceptable thresholds defined by the user for each stimulus parameter and stored in database 118 to determine whether the response of robot 120 to the transmitted stimulus parameters meets the non-functional test requirements. For example, controller program 106 may compare the response time of a response by robot 120 to a visual stimulus to a pre-defined response time criteria. In another example, controller program 106 may compare the recorded angular velocity, final angle and final position of component 122₁ to the pre-defined values for those characteristics in response to an aural stimulus, such as a command to “Wave to the audience.” In a further example, controller program 106 may compare a variation in slack time of two simultaneous, parallel actions, such as speaking a verbose response and moving a component.

If controller program 106 determines that the results do not meet a requirement (“no” branch, decision block 214), then controller program 106 marks the results as a fail (step 216). Controller program 106 flags any results of the non-functional testing that do not meet the pre-defined criteria, tolerances or acceptable thresholds stored in database 118. In an embodiment where controller program 106 does not find an associated criteria, tolerance, or acceptable threshold in database 118 for a stimulus parameter received from agent(s) 124, controller program 106 may flag the result as missing a requirement or as an unidentified reference. In an embodiment where controller program 106 flags a missing requirement, controller program 106 may notify the user, via user interface 108, that a requirement is missing.

If controller program 106 determines that the results meet a requirement (“yes” branch, decision block 214), or responsive to marking the results as a fail, controller program 106 generates test results (step 218). Controller program 106 compiles the results of the non-functional requirements test of the received stimulus parameters and generates a report. In one embodiment, controller program 106 stores the report in database 118 for the user to access via user interface 108. In another embodiment, controller program 106 may display the report directly to the user via user interface 108. In a further embodiment, controller program 106 may transmit the results as an email or text message to the user.

FIG. 3 depicts a block diagram of components of non-functional requirements (NFR) stimulus tester 104 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

NFR stimulus tester 104 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., controller program 106 and database 118, are stored in persistent storage 308 for execution and/or access by one or more of the respective processor(s) 304 of NFR stimulus tester 104 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of robot 120. In these examples, communications unit 310 includes one or more network interface cards. Communications unit 310 may provide communications through the use of either or both physical and wireless communications links. Controller program 106, database 118, and other programs and data used for implementation of the present invention, may be downloaded to persistent storage 308 of NFR stimulus tester 104 through communications unit 310.

I/O interface(s) 312 allows for input and output of data with other devices that may be connected to NFR stimulus tester 104. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., controller program 106 and database 118 on NFR stimulus tester 104, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as

Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for non-functional requirement stimulus testing of a robot, the method comprising:
receiving, by one or more computer processors, one or more stimulus parameters to test;
triggering, by the one or more computer processors, the one or more stimulus parameters in a robot; and
determining, by the one or more computer processors, at least one response time to the one or more stimulus parameters.

2. The method of claim 1, wherein determining at least one response time to the one or more stimulus parameters further comprises:
determining, by the one or more computer processors, a first time when the robot received the one or more stimulus parameters;
determining, by the one or more computer processors, a second time when the robot responds to the one or more stimulus parameters;
based, at least in part, on the first time and the second time, calculating, by the one or more computer processors, a response time; and
comparing, by the one or more computer processors, the response time to one or more pre-defined response time criteria.

3. The method of claim 1, further comprising:
responsive to determining at least one response time to the one or more stimulus parameters, determining, by the one or more computer processors, whether the at least one response time meets a requirement; and
responsive to determining the at least one response time does not meet a requirement, marking, by the one or more computer processors, the at least one response time as a fail.

4. The method of claim 3, wherein determining whether the at least one response time meets a requirement further comprises, comparing, by the one or more computer processors, the at least one response time to at least one of a criteria, a tolerance, and an acceptable threshold value.

5. The method of claim 4, further comprising, responsive to not finding at least one of a criteria, a tolerance, and an acceptable threshold value, flagging, by the one or more computer processors, the at least one response time as missing a requirement.

6. The method of claim 1, further comprising:
determining, by the one or more computer processors, a type of response to the one or more stimulus parameters; and
determining, by the one or more computer processors, metadata associated with the response, wherein metadata is selected from the group consisting of a clarity of an audio response, an angular velocity, a final angle, and a final position of a moving component.

7. The method of claim 1, wherein receiving one or more stimulus parameters to test further comprises receiving, by the one or more computer processors, a verbose command via natural language processing techniques.

8. The method of claim 1, further comprising, based, at least in part, on the at least one response time to the one or more stimulus parameters, generating, by the one or more computer processors, a report.

9. A computer program product for non-functional requirement stimulus testing of a robot, the computer program product comprising:
one or more computer readable storage devices and program instructions stored on the one or more computer readable storage devices, the stored program instructions comprising:
program instructions to receive one or more stimulus parameters to test;
program instructions to trigger the one or more stimulus parameters in a robot; and
program instructions to determine at least one response time to the one or more stimulus parameters.

10. The computer program product of claim 9, wherein the program instructions to determine at least one response time to the one or more stimulus parameters comprise:
program instructions to determine a first time when the robot received the one or more stimulus parameters;
program instructions to determine a second time when the robot responds to the one or more stimulus parameters;
based, at least in part, on the first time and the second time, program instructions to calculate a response time; and
program instructions to compare the response time to one or more pre-defined response time criteria.

11. The computer program product of claim 9, the stored program instructions further comprising:
responsive to determining at least one response time to the one or more stimulus parameters, program instructions to determine whether the at least one response time meets a requirement; and
responsive to determining the at least one response time does not meet a requirement, program instructions to mark the at least one response time as a fail.

12. The computer program product of claim 11, wherein the program instructions to determine whether the at least one response time meets a requirement comprise, program instructions to compare the at least one response time to at least one of a criteria, a tolerance, and an acceptable threshold value.

13. The computer program product of claim 12, the stored program instructions further comprising, responsive to not finding at least one of a criteria, a tolerance, and an acceptable threshold value, program instructions to flag the at least one response time as missing a requirement.

14. The computer program product of claim 9, the stored program instructions further comprising:
program instructions to determine a type of response to the one or more stimulus parameters; and
program instructions to determine metadata associated with the response, wherein metadata is selected from the group consisting of a clarity of an audio response, an angular velocity, a final angle, and a final position of a moving component.

15. A computer system for non-functional requirement stimulus testing of a robot, the computer system comprising:
one or more computer processors;
one or more computer readable storage devices;
program instructions stored on the one or more computer readable storage devices for execution by at least one of the one or more computer processors, the stored program instructions comprising:
program instructions to program instructions to receive one or more stimulus parameters to test;
program instructions to trigger the one or more stimulus parameters in a robot; and
program instructions to determine at least one response time to the one or more stimulus parameters.

16. The computer system of claim 15, wherein the program instructions to determine at least one response time to the one or more stimulus parameters comprise:
program instructions to determine a first time when the robot received the one or more stimulus parameters;
program instructions to determine a second time when the robot responds to the one or more stimulus parameters;
based, at least in part, on the first time and the second time, program instructions to calculate a response time; and
program instructions to compare the response time to one or more pre-defined response time criteria.

17. The computer system of claim 15, the stored program instructions further comprising:
responsive to determining at least one response time to the one or more stimulus parameters, program instructions to determine whether the at least one response time meets a requirement; and
responsive to determining the at least one response time does not meet a requirement, program instructions to mark the at least one response time as a fail.

18. The computer system of claim 17, wherein the program instructions to determine whether the at least one response time meets a requirement comprise, program instructions to compare the at least one response time to at least one of a criteria, a tolerance, and an acceptable threshold value.

19. The computer system of claim 18, the stored program instructions further comprising, responsive to not finding at least one of a criteria, a tolerance, and an acceptable threshold value, program instructions to flag the at least one response time as missing a requirement.

20. The computer system of claim 15, the stored program instructions further comprising:
program instructions to determine a type of response to the one or more stimulus parameters; and
program instructions to determine metadata associated with the response, wherein metadata is selected from the group consisting of a clarity of an audio response, an angular velocity, a final angle, and a final position of a moving component.
